(19) United States
(12) Patent Application Publication
(10) Pub. No.: US 2016/0301130 A1
(43) Pub. Date: Oct. 13, 2016

(54) Radio Frequency Hat System

(71) Applicant: Felipe Nazario-Romero, California, MD (US)

(72) Inventor: Felipe Nazario-Romero, California, MD (US)

(73) Assignee: United States of America as represented by the Secretary of the Navy, Patuxent River, MD (US)

(21) Appl. No.: 14/644,696

(22) Filed: Apr. 13, 2015

(51) Int. Cl. H01Q 1/52; H01Q 9/16

(52) U.S. Cl. CPC H01Q 1/526; H01Q 9/16

(57) ABSTRACT

The present invention is directed to a radio frequency hat system for decreasing transmission power when conducting tests on the ground, which includes a first hat and a second hat. The first hat corresponds to a lower transmitting conformal IFF antenna, and the second hat corresponds to an upper transmitting conformal IFF antenna. The first hat and the second hat are made from frequency selective material (FSM). The first hat has a first hat dipole, and the second hat has a second hat dipole. The first hat dipole and the second hat dipole are able to transmit and receive communications at a decreased transmission level during testing.

### STATEMENT OF GOVERNMENT INTEREST

The invention described herein may be manufactured and used by or for the Government of the United States of America for governmental purposes without payment of any royalties thereon or therefor.

### BACKGROUND

Test personnel must gather data from emissions of aircraft, particularly military aircraft. This data is necessary for certifying equipment. Currently, methods exist to gather the required emissions/data that minimize the impact of unwanted emissions into the National Airspace, and the health and safety of the testing personnel. However, these methods are not able to be effectively used on the Joint Strike Fighter, due to the unique characteristics of the Joint Strike Fighter. Tests for the Conformal Identification System require close contact to the conformal antennas and the measuring equipment to ensure there is no interference from other sources. The Identification System or Identification Friend or Foe (IFF) system provides information to the. Air Traffic Controller (ATC) consisting of basic information on the aircraft (altitude, “who am I”/flight number). This information, radiated over the international frequency of 1090 MHz, goes to all receivers dedicated to ATC functions. During flight, the aircraft can receive multiple requests for identification, causing the aircraft to respond back to the “interrogations.” The IFF system uses the antennas located at the top and the bottom of the aircraft to transmit this information (particularly the Joint Strike Fighter).

The currently used method for gathering emissions data from aircraft requires personnel to walk up to the aircraft, and physically place an antenna as close as possible to the aircraft in order to record the emissions through test equipment. These measurements are not representative of the actual transmission coming from the aircraft. In addition, it is a violation of FAA regulations for unwanted transmissions coming from ground tests to be in the IFF band. Additionally, personnel must stay close to the aircraft while holding an antenna for the top part of the aircraft. This also creates a safety and health hazard.

The United States Navy utilizes radio frequency hats that decrease the level of transmission. Military aircraft radio frequency hats are a series of test equipment covers used to receive, record, and transmit emissions from the aircraft's small conformal identification antennas. The hats cover the conformal antennas and allow measuring data and signals while decreasing the level of transmission. Conformal antennas are typically designed into the aircraft's fuselage, matching the shape of the aircraft in order to maintain aerodynamic characteristics.

### SUMMARY

The present invention is directed to a radio hat frequency system with the needs enumerated above and below.

The present invention is directed to a radio frequency hat system for decreasing transmission power when conducting tests on the ground, which includes a first hat and a second hat. The first hat corresponds to a lower transmitting conformal IFF antenna, and the second hat corresponds town upper transmitting conformal IFF antenna. The first hat and the second hat are made from frequency selective material (FSM). Frequency selective material (FSM) may be defined, but without limitation, as material that can isolate specific frequencies by blocking some frequencies while allowing others to go through the material. The first hat has a first hat dipole, and the second hat has a second hat dipole. The first hat dipole and the second hat dipole are able to transmit and receive communications at a decreased transmission level during testing.

It is a feature of the present invention to provide a radio hat frequency system that is inexpensive, easy and safe to use.

It is a feature of the present invention to provide a radio hat frequency system that is not in violation of any FAA rules.

It is a feature of the present invention to provide a radio frequency hat system that can be used for a series of tests requiring measurements of transmissions from conformal antennas, while attenuating the signal to comply with federal guidelines concerning transmissions into national airspace.

### DRAWINGS

These and other features, aspects and advantages of the present invention will become better understood with reference to the following description and appended claims, and accompanying drawings wherein:

FIG. 1 is a side view of the radio frequency hat system in operation;

FIG. 2A is a perspective view of the first hat;

FIG. 2B is a top view of the first hat;

FIG. 2C is a perspective view of the first hat and neck structure on a tripod;

FIG. 2D is a side view of the first hat and neck structure;

FIG. 3A is perspective bottom view of the second hat;

FIG. 3B is a bottom view of the second hat; and,

FIG. 3C is a side view of the second hat.

### DESCRIPTION

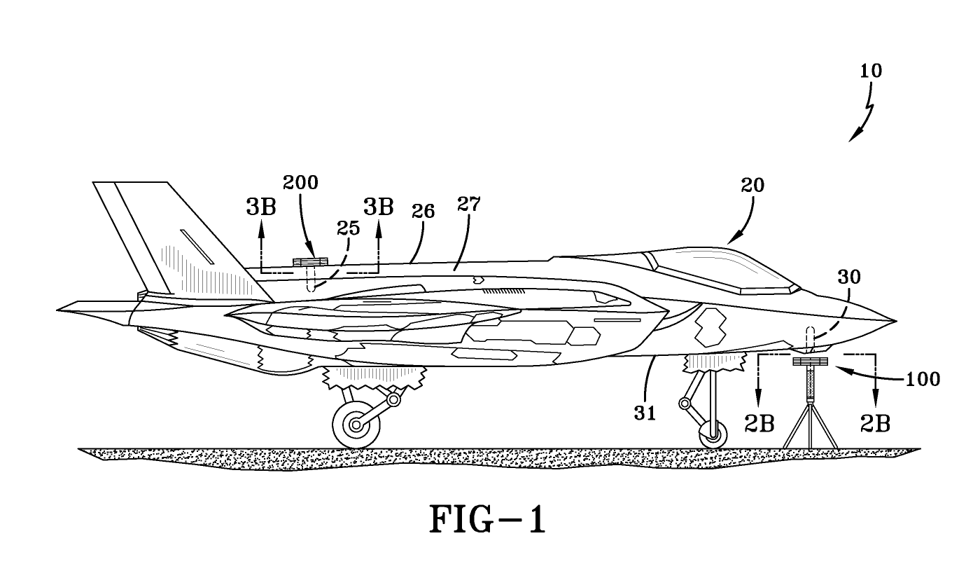

The preferred embodiments of the present invention are illustrated by way of example below and in FIGS. 1-3. As shown in FIG. 1, the radio frequency hat system 10 for decreasing transmission power when conducting tests on the ground includes a first hat 100 corresponding to a lower transmitting conformal IFF antenna 30, and a second hat 200 corresponding to an upper transmitting conformal IFF antenna 25. The first hat 100 and the second hat 200 are made from frequency selective material 250. The first hat 100 has a first hat dipole 105, and the second hat 200 has a second hat dipole 205. The dipoles 105, 205 are able to transmit and receive communications at a decreased transmission level during testing.

In the description of the present invention, the invention will be discussed in a military aircraft environment; however, this invention can be utilized for any type of application that requires use of a radio frequency hat system that decreases the power of transmissions.

In operation, the first hat 100 corresponds the lower transmitting conformal IFF antenna 30, while the second hat 200 covers the upper transmitting conformal IFF antenna 25. If an aircraft only has one transmitting IFF antenna then the system 10 only utilizes one hat appropriate to the location of the antenna. As shown in FIG. 1, in an aircraft 20, the upper transmitting conformal IFF antenna 25 may be located on the top portion 26 of the aircraft 20 beneath the skin 27 of the aircraft 20. The lower transmitting conformal IFF antenna 30 may be located on the lower or underside 31 of the aircraft 20 beneath the skin 27. The first hat 100 is pressed up against the lower transmitting conformal IFF antenna 30.

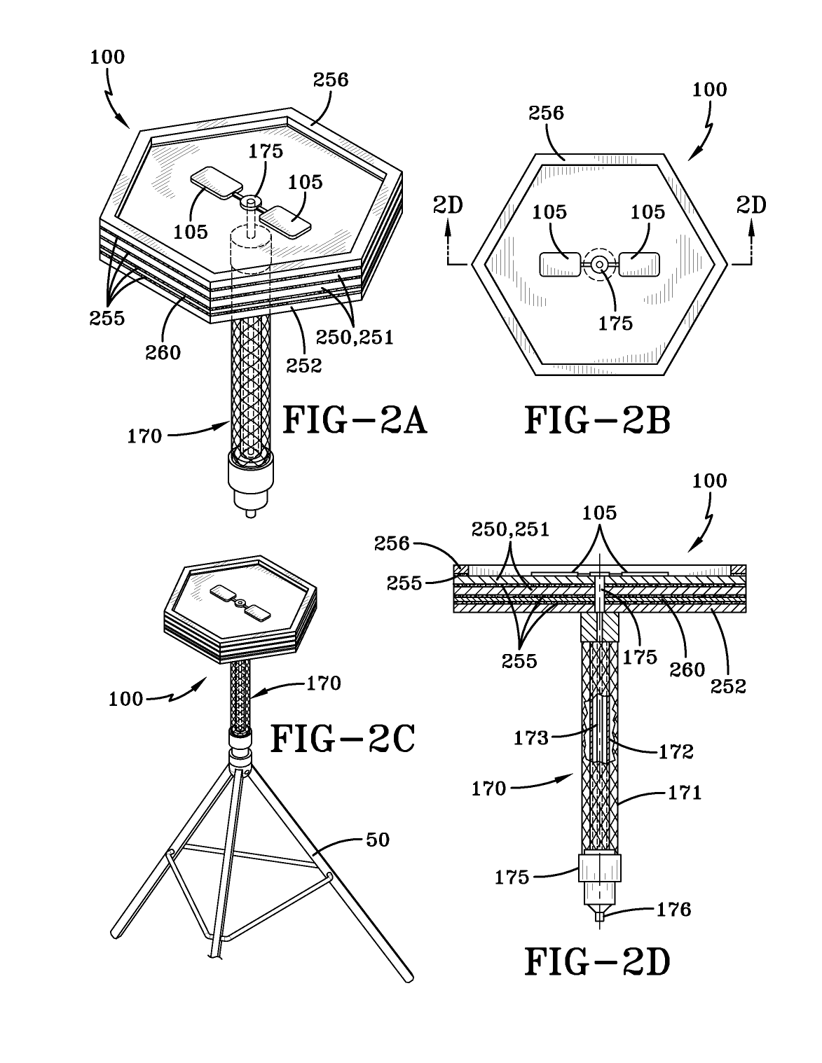

The first hat 100 may include a combination of frequency selective material (FSM) 250, an acrylic layer 252, an aluminum foil layer 260, a polymer adhesive 255, a dipole 105, and hardware to connect the test equipment or particularly an radio frequency (RF) connector 175. In the preferred embodiment, as shown in FIGS. 2A and 2D, the top layer may be a first FSM layer 251, the second layer a second FSM layer 251, on top of the aluminum foil layer 260 (or any type of reflective layer), on top of the acrylic layer 252 (or any type of layer that provides rigidity). However, the layers may be positioned in any order practicable, with the exception of the layer closest to the aircraft, which should be a FSM layer. The layers may be attached to each other via the polymer adhesive 255 but any connection method or adhesive that is practicable may be utilized. On top of the first FSM layer 251, there may be a FSM lip 256 that extends around the perimeter of the first hat 100. The FSM lip 256 ensures a tight fit around the skin 27 of the aircraft 20 so that signals can be attenuated, while the acrylic layer 252 provides rigidity to the first hat 100.

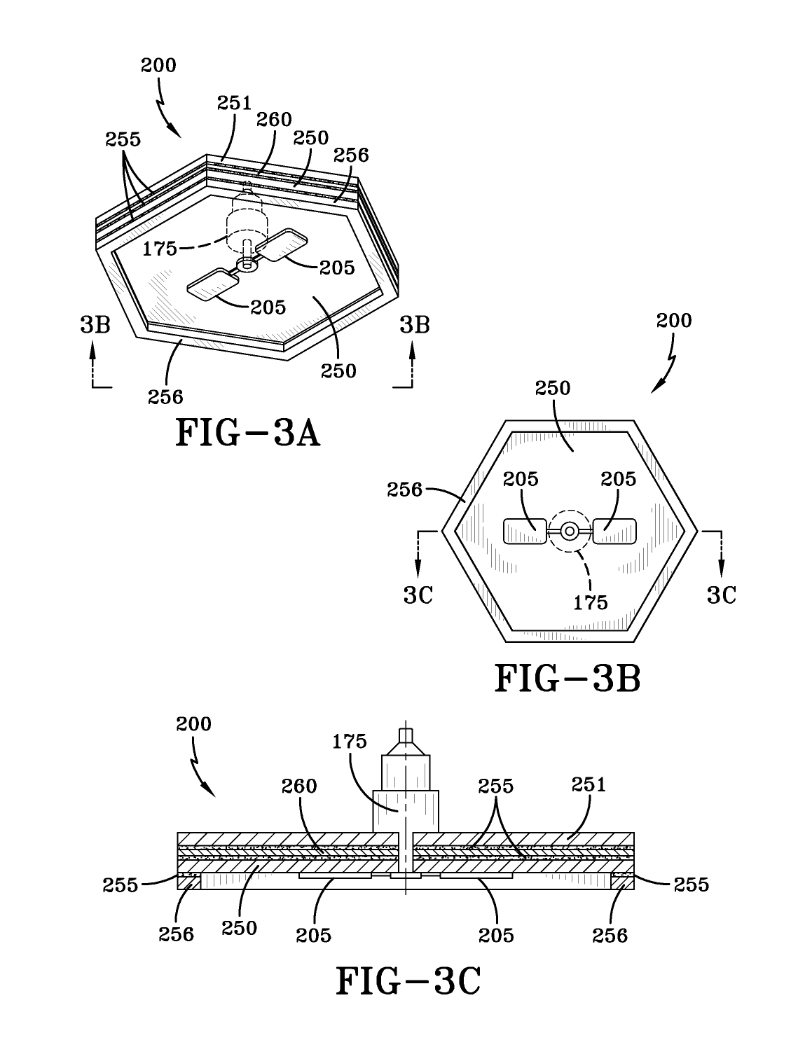

In the preferred embodiment, as shown in FIGS. 3A, 3B, and 3C, the second hat 200 includes a FSM lip 256 extending around the perimeter of the second hat 200 (to provide a tight fit around the skin 27 of the aircraft 20), an FSM layer 251, and an aluminum foil layer 260. In the preferred embodiment there are two FMS layers. The layers may be positioned in any order practicable, with the exception of the layer closest to the aircraft, which should be a FSM layer. In the approximate center of the second hat 200, there is a RF connector 175. This RF connector 175 and any other RF connectors utilized in the invention allow communication and connection to any type of equipment specifically, but without limitation, equipment for analyzing equipment, such as, a test set, an oscilloscope, computer, a Spectrum Analyzer, an RF Power Meter, and any other common RF measuring devices.

The FSM layer 251 may be a semi-rubber synthetic material tuned specifically for the frequency required for the transmission in the IFF band. In the preferred embodiment of the invention, the first hat 100 and the second hat 200 are substantially hexagonally shaped. The aluminum foil layer 260 works as a reflector to ensure no emissions go beyond the FSM layer. The polymer adhesive 255 may be a simple room temperature vulcanization (RTV) used to fasten the different materials. However, any type of fastener that is practicable can be used.

Each dipole 105, 205 will receive from, and transmit to, corresponding conformal antennas 25, 30. In the preferred embodiment, each dipole 105, 205 is a frequency tuned copper strip to ensure maximum reception on the required IFF band.

The first hat 100 has a neck structure 170 protruding from its approximate center. In the preferred embodiment, as shown in FIGS. 2A, 2C, and 2D, the neck structure 170 includes a damper system which allows vertical adjustment of the first hat. As shown in FIG. 2D, in the preferred embodiment, the damping system includes a spring mesh 171 wrapped around damper tubing 172 and a cable 173. At one end of the neck structure 170 the first hat 100 is disposed and it is communicating with an RF connector 175. At the other end of the neck structure 170 another RF connector is disposed. The two RF connectors 175 communicate via the cable 173, which may be an RF cable. The neck structure 170 is attached to the first hat 100 on one end and is connected to a tripod 50 or any type of holding structure on its other end. The neck structure 170 is attached to the tripod 50 via a machined neck 176, while the second hat 200 does not require connection to a tripod because the weight of the second hat 200 holds the second hat 200 in place. The tripod 50 may be any type of holding structure that can be vertically adjusted such that in conjunction with the damper tubing 172 and the spring mesh 171, there is a snug fit between the skin 27 of the aircraft 20 and the first hat 100 (particularly the lip 256 of the first hat 100).

In the description of the present invention, the invention will be discussed in an aircraft and ship environment; however, this invention can be utilized for any type of application that requires use of a battery.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A radio frequency hat system for decreasing transmission power when conducting tests on the ground, the system comprising:
a first hat corresponding to a lower transmitting conformal IFF antenna, the first hat comprising of frequency selective material and a first hat dipole; and,
a second hat corresponding to an upper transmitting conformal IFF antenna, the second hat comprising frequency selective material and a second hat dipole, the first hat dipole and the second hat dipole able to transmit and receive communications at a decreased transmission level during testing.

2. The radio frequency hat system of claim 1, wherein the first hat is comprised of a first frequency selective material layer, a reflective layer, a rigid layer, and a second frequency selective material layer.

3. The radio frequency hat system of claim 2, wherein the first hat includes a first hat perimeter and a first hat frequency selective material lip that extends around the first hat perimeter.

4. The radio frequency hat system of claim 3, wherein the second hat is comprised a first frequency selective material layer, a reflective layer, and a second frequency selective material layer.

5. The radio frequency hat system of claim 4, wherein the second hat includes a second hat perimeter and a second frequency selective material lip that extends around the second hat perimeter.

6. The radio frequency hat system of claim 5, wherein the first hat dipole and the second hat dipole are frequency tuned copper strips.

7. A radio frequency hat system for decreasing transmission power when conducting tests on the ground, the system comprising:
a first hat corresponding to a lower transmitting conformal IFF antenna, the first hat comprising of a first hat dipole, a first frequency selective material layer, a reflective layer, a rigid layer, and a second frequency selective material layer;
a second hat corresponding to an upper transmitting conformal IFF antenna, the second hat comprising a second hat dipole, a first frequency selective material layer, a reflective layer, and a second frequency selective material layer, the first hat dipole and the second hat dipole able to transmit and receive communications at a decreased transmission level during testing; and a,
a neck structure protruding from the first hat, the neck structure including a damper system allowing vertical adjustment of the first hat.

8. The radio frequency hat system of claim 7, wherein the first hat and second hat communicate with IFF connectors that allow communication between the antennas and a test set.
